(19) United States
(12) Patent Application Publication
(10) Pub. No.: US 2015/0239434 A1
(43) Pub. Date: Aug. 27, 2015

(54) WINDSCREEN WIPER INCLUDING A HEATING ELEMENT

(71) Applicant: Valeo Systèmes d'Essuyage, Le Mesnil Saint Denis (FR)

(72) Inventors: Gérald Caillot, Cernay La Ville (FR); Vincent Izabel, Chilly Mazarin (FR); Jean-Michel Jarasson, Le Mesnil Saint Denis (FR)

(73) Assignee: Valeo Systèmes d'Essuyage, Le Mesnil Saint Denis (FR)

(21) Appl. No.: 14/628,742

(22) Filed: Feb. 23, 2015

(30) Foreign Application Priority Data
Feb. 24, 2014 (FR) 1451455

(51) Int. Cl. B60S 1/38; B60S 1/52

(52) U.S. Cl. CPC B60S 1/3805; B60S 1/524; B60S 1/3875

(57) ABSTRACT

A heating windscreen wiper includes a support element for a wiper blade, at least one spine-forming elongate element, and at least one heating element positioned on a face of the spine-forming elongate element. The windscreen wiper also includes a spacing means arranged to avoid physical contact between the heating element and the support element.

The invention relates to a windscreen wiper including a heating element, notably a flexible windscreen wiper or a flat windscreen wiper.

A windscreen wiper includes a wiper blade intended to clean a windscreen of a motor vehicle.

The wiper blade is borne by a support element. This support element contains a spine-forming elongate element.

The spine-forming elongate element has a concave bottom face intended to be turned toward the windscreen of a vehicle for which the windscreen wiper is intended, and a top face opposite said concave bottom face.

Heating devices for windscreen wipers are known that include a heating element incorporated in the body of the windscreen wiper and that extend generally over the length thereof.

The heating element makes it possible to melt ice or snow which can be formed or can build up on the windscreen wiper.

Such a heating element is particularly useful for equipping windscreen wipers provided with a washing liquid dispensing spray boom. The heating element makes it possible, in this case, to reheat the dispensing spray boom and in particular the dispensing holes to enable the washing liquid to exit and wash the windscreen of the vehicle for which the windscreen wiper is intended.

When the heating element is constructed in the form of a heating film or a heating coating, this heating element can be positioned by bonding or by another adhesion means onto the concave bottom face of the spine-forming elongate element.

However, this spine-forming elongate element is inserted into the support element of the wiper blade.

This positioning of the heating element on the concave bottom face of the spine-forming elongate element presents a number of drawbacks.

Firstly, the thermal contact between the heating element and the support element made of flexible material risks damaging, or degrading, the flexible material of the support element, particularly in the case where this support element is a flat channel support element in contact over its entire width with the heating element.

Then, in the case where the thermal loading of the heating film has to be increased to obtain a more effective thermal transfer, the risk of thermal degradation of the support element further increases.

A first aim of the invention is to remedy the drawbacks of the known prior art, by proposing a novel heating windscreen wiper that allows for the use of a support element, while avoiding the risk of thermal degradation of the support element.

A second aim of the invention is to propose a novel heating windscreen wiper, avoiding the risks of degradation of the support element by the heat emitted by the heating element.

A third aim of the invention is to make it possible to reduce the power of the heating film, so as to minimize the risks of degradation of the support element.

The subject of the invention is a windscreen wiper, notably for a motor vehicle, comprising:
a support element for a wiper blade,
at least one spine-forming elongate element,
at least one heating element in contact with a face of the spine-forming elongate element, characterized in that the windscreen wiper comprises a spacing means arranged to avoid physical contact between the heating element and the support element.

According to other alternative features of the invention:
the heating element is in contact with the concave bottom face of the spine-forming elongate element.
the spacing means is positioned between the spine-forming elongate element and the support element.
the support element of the wiper blade has a housing at least partially surrounding the spine-forming elongate element.

Provision can be made for the spacing means to consist of at least one shoulder of the support element and, preferably, two lateral shoulders on the support element in order to eliminate or minimize the thermal contact between the heating film and the support element, without compromising the good thermal transfer between the heating element and the surfaces to be reheated on the side of the support element.

According to advantageous variants of the invention, the novel heating device according to the invention is arranged with a flat channel support element, without lateral shoulders, and does not lead to a reduction of the flexibility of the windscreen wiper, while avoiding the risks of degradation of the support element by the heat emitted by the heating element.

According to other alternative features of these advantageous variants of the invention, the spacing means is distinct from the support element, and:
the spacing means is provided between the heating element and the flat channel support element and inside the flat channel-form housing at least partially surrounding the spine-forming elongate element, to avoid a direct thermal transfer between the heating element and the flat channel support element.
the spacing means can be positioned on the concave bottom face of the spine-forming elongate element and separated from the heating element.
the spacing means provided between the heating element and the flat channel support element can be positioned on the heating element.
the spacing means provided between the heating element and the flat channel support element can be incorporated in the heating element and includes at least one non-heating, cold or thermally insulating part.
the spacing means provided on the side of the concave bottom face of the elongate element can consist of at least one overthickness of a sheath surrounding the spine-forming elongate element.

Another subject of the invention is a heating windscreen wiper according to the particular invention, namely a windscreen wiper provided with a spray boom for spraying a washing liquid.

The invention will be better understood from the following description, given as a nonlimiting example, with reference to the attached drawings in which:

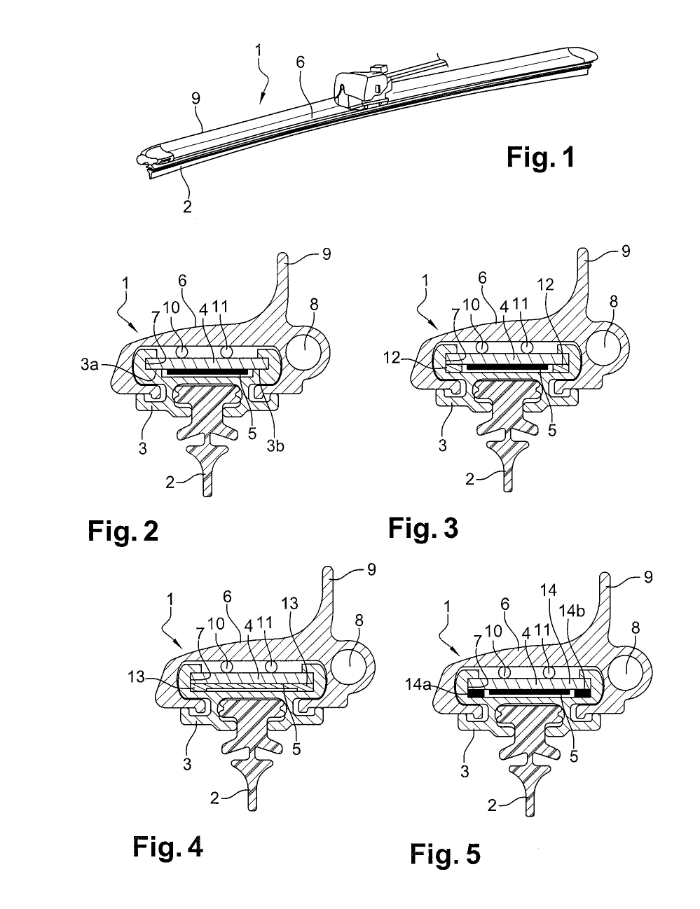

FIG. 1 schematically represents a perspective view of a first embodiment of a windscreen wiper according to the invention linked to an actuation arm.

FIG. 2 schematically represents a cross-sectional view of the windscreen wiper according to the invention of FIG. 1.

FIG. 3 schematically represents a cross-sectional view of a second embodiment of a windscreen wiper according to the invention.

FIG. 4 schematically represents a cross-sectional view of a third embodiment of a windscreen wiper according to the invention.

FIG. 5 schematically represents a cross-sectional view of a fourth embodiment of a windscreen wiper according to the invention.

With reference to FIGS. 1 to 5, the identical or functionally equivalent elements are identified by identical reference numerals.

In FIGS. 1 and 2, a first embodiment of a windscreen wiper according to the invention, denoted overall by the reference (1), is advantageously a flexible windscreen wiper or flat windscreen wiper, exhibiting great flexibility.

This flexible windscreen wiper (1) includes a wiper blade (2), generally made of elastomer, intended for cleaning a windscreen of a motor vehicle, for which the windscreen wiper is intended.

The wiper blade (2) made of elastomer is borne by a support element (3). The support element (3) includes two shoulders (3a, 3b) and contains a spine-forming elongate element (4).

A heating element (5) made up in the form of a film or coating is positioned on the concave bottom face of the spine-forming elongate element (4).

A cover element (6) is fixed onto the support element (3) by snap-fitting.

The cover element (6) can include a spray boom (8) for spraying washing liquid and/or an aerodynamic baffle (9) making it possible to press the wiper blade (2) against a window which is not represented of a vehicle which is not represented.

The invention also extends to any variant cover element including or not including aerodynamic baffles and including or not including spray booms for spraying washing liquid.

The spine-forming element (4) is inserted into a housing (7) formed inside the support element (3).

The spine-forming element (4) has, on its top face, two electrical conductors (10, 11) supplying power to the heating element (5) positioned on its concave bottom face.

In other words, the electrical conductors (10, 11) are positioned on a face of the spine-forming elongate element (4) opposite the face receiving the heating element (5).

By virtue of the shoulders (3a, 3b), the heating film (5) is kept away from the support element (3), so as to avoid any thermal degradation of the support element (3) when the heating film (5) is electrically powered by the conductors (10 and 11).

The presence of the shoulders (3a, 3b) slightly increases the rigidity of the support element (3), such that the pressing onto a vehicle window is less emphasized, in particular in the case of a domed windscreen or of high-speed movements.

It is possible to envisage eliminating the shoulders (3a, 3b) of the support element (3) to adopt flat channel form, without any internal shoulder, in order to retain a greater flexibility in the support element (3).

The invention consequently also applies to support elements in which the housing (7) has a flat channel structure, without any shoulder of the kind of the shoulders (3a, 3b).

This flat channel structure, without any shoulder, is similar to that of the support elements of the flexible windscreen wipers according to the invention that do not include any heating element.

In FIG. 3, a second embodiment of a windscreen wiper according to the invention includes elements that are identical or functionally equivalent to the elements of FIGS. 1 and 2.

The wiper blade (2), generally made of elastomer, is borne by a support element (3).

The support element (3) contains a spine-forming elongate element (4), and a heating element (5) constructed in the form of a film or coating is positioned on the concave bottom face of the spine-forming elongate element (4).

A cover element (6) is fixed onto the support element (3) by snap-fitting. The spine-forming element (4) is inserted into a flat channel housing (7) formed inside the support element (3).

The spine-forming element (4) has, on its top face, two electrical conductors (10 and 11) supplying power to the heating element (5) positioned on its concave bottom face.

Spacing means (12) are provided and positioned on the concave bottom face of the spine-forming element (4) to separate the heating element (5) from the internal face of the support element (3).

These spacing means (12) are advantageously fixed under the concave bottom face of the spine-forming element (4) and are constructed, for example, in the form of flexible strips with no contact with the heating element (5).

By separating the spacing means (12) from the heating element (5), it becomes possible to use a flexible material, not necessarily resistant to the heat transmitted by the heating element (5) towards the support element (3).

In FIG. 4, a third embodiment of a windscreen wiper according to the invention includes elements that are identical or functionally equivalent to the elements of FIG. 3.

The wiper blade (2), generally made of elastomer, is borne by a support element (3).

The support element (3) contains a spine-forming element (4).

A heating element (5) constructed in the form of a film or coating is positioned on the concave bottom face of the spine-forming elongate element (4).

A cover element (6) is fixed onto the support element (3) by snap-fitting.

The spine-forming element (4) is inserted into a flat channel housing (7) formed inside the support element (3).

The spine-forming element (4) has, on its top face, two electrical conductors (10 and 11) supplying power to the heating element (5) positioned on its concave bottom face.

Spacing means (13) positioned on the heating element (5) are provided to separate the active part of the heating film (5) from the support element (3).

The spacing elements (13) can consist of non-heating cold edges of the heating element (5), in contact with the support element (3).

Said spacing means (13) positioned on the heating element (5) can also be positioned on the heating element (5), forming thermally insulating lateral edges.

Said spacing means (13) positioned on the heating element (5) can also be incorporated in the heating element (5) and can consist of edges exhibiting a weak thermal transmission.

In FIG. 5, a fourth embodiment of a windscreen wiper according to the invention includes elements that are identical or functionally equivalent to the elements of FIG. 4.

The wiper blade (2), generally made of elastomer, is borne by a support element (3). The support element (3) contains a spine-forming elongate element (4).

A heating element (5) constructed in the form of a film or coating is positioned on the concave bottom face of the spine-forming elongate element (4).

A cover element (6) is fixed onto the support element (3) by snap-fitting.

The spine-forming element (4) is inserted into a flat channel housing (7) formed inside the support element (3). The spine-forming element (4) has, on its top face, two electrical conductors (10 and 11) supplying power to the heating element (5) positioned on its concave bottom face.

Spacing means (14a, 14b) are provided to separate the heating element (5) from the bottom face of the support element (3).

In the case where the spine-forming element (4) is constructed in the form of a metal blade surrounded by a coating of plastic material, for example of polyethylene terephthalate (PET), the spacing elements (14a, 14b) can advantageously consist of overthicknesses of the polyethylene terephthalate (PET) jacket of the spine-forming element (4).

This arrangement makes it possible to replace a spine (4) of the usual type with a spine (4) of lesser thickness surrounded by a coating of polyethylene terephthalate that has overthicknesses.

This arrangement thus makes it possible to standardize the manufacture of the parts between windscreen wipers of the usual type and windscreen wipers according to the invention, because the dimensions of the other essential parts such as the wiper blade (2), the support element (3) and the cover element (6) are unchanged. This standardization thus allows for interchangeability of the parts and corresponding stock saving.

The invention described with reference to a plurality of particular embodiments is in no way limited thereto, and on the contrary covers any alteration of form and any variant production in the context of the attached claims.

1. A windscreen wiper for a motor vehicle, comprising:
a support element for a wiper blade;
at least one spine-forming elongate element;
at least one heating element in contact with a face of the spine-forming elongate element; and
a spacing means arranged to prevent physical contact between the heating element and the support element.

2. The windscreen wiper according to claim 1, wherein the heating element is in contact with the concave bottom face of the spine-forming elongate element.

3. The windscreen wiper according to claim 1, wherein the spacing means is positioned between the spine-forming elongate element and the support element.

4. The windscreen wiper according to claim 1, wherein the support element of the wiper blade has a flat channel-form housing at least partially surrounding the spine-forming elongate element.

5. The windscreen wiper according to claim 1, wherein the spacing means consists of at least one shoulder of the support element.

6. The windscreen wiper according to claim 1, wherein the spacing means is distinct from the support element.

7. The windscreen wiper according to claim 6, wherein the spacing means is provided between the heating element and the support element and inside the housing.

8. The windscreen wiper according to claim 6, wherein the spacing means is positioned on the concave bottom face of the spine-forming elongate element and separated from the heating element.

9. The windscreen wiper according to claim 6, wherein the spacing means provided between the heating element and the support element is positioned on the heating element.

10. The windscreen wiper according to claim 6, wherein the spacing means provided between the heating element and the support element is incorporated in the heating element and includes at least one non-heating, cold or thermally insulating part.

11. The windscreen wiper according to claim 6, wherein the spacing means provided on the side of the concave bottom face of the spine-forming elongate element consists of at least one overthickness of a sheath surrounding the spine-forming elongate element.

12. The windscreen wiper according to claim 1, wherein the electrical conductors are positioned on a face of the spine-forming elongate element opposite the face receiving the heating element.

13. The windscreen wiper according to claim 1, further comprising at least one spray boom or a means for spraying windscreen washing liquid.
